(19) United States
(12) Patent Application Publication
(10) Pub. No.: US 2006/0127662 A1
(43) Pub. Date: Jun. 15, 2006

(54) Process for making biopreform from monocotyledonous caudex plant stem, biopreform obtained thereby and use thereof

(75) Inventors: Omprakash Chakrabarti, West Bengal (IN); Himadri Sekhar Maiti, West Bengal (IN); Rabindranath Mazumdar, West Bengal (IN)

Correspondence Address: DARBY & DARBY P.C., P. O. BOX 5257, NEW YORK, NY, 10150-5257, US

(73) Assignee: Council of Scientific and Industrial Research

(21) Appl. No.: 11/347,602

(22) Filed: Feb. 3, 2006

Related U.S. Application Data
(63) Continuation of application No. 10/334,676, filed on Dec. 30, 2002, now abandoned.

(51) Int. Cl. D02G 3/02; B32B 5/14

(52) U.S. Cl. 428/308.8; 428/17; 428/304.4; 428/306.6; 428/358; 428/372

(57) ABSTRACT

A method of making biopreform from the stem of monocotyledonous caudex plant, that is suitable for liquid infiltration and gaseous transportation of materials, is disclosed. Wood from caudex stem of trees such as coconut (Cocos nucifera), palmyra palm (Borassus flabellifer), date palm (Phoenics dactylifera), is used as a precursor material which is transformed under simple pyrolitic conditions under self-generated ambient atmosphere to biopreform having microstructural features typical of a monocotyledonous caudex tree. The biopreform is capable of liquid infiltration and gaseous transportation processing of materials in an appreciably shorter processing periods, because of its preservation of the structural and anatomical features of the parent plants with high precision.

### FIELD OF THE INVENTION

The present invention relates to a process of making biopreform from monocotyledonous caudex plant stem. More particularly, the present invention relates to a process for making a biopreform from monocotyledonous caudex plant stem that is suitable for liquid infiltration and gaseous transportation processing of materials. The present invention also relates to a ceramic composite material prepared using the biopreform of the invention.

### BACKGROUND OF THE INVENTION

Synthesis of materials from naturally grown plant structures has recently received interests. Plants often possess natural composite structures and exhibit high anisotropic mechanical strength, low density, high stiffness, elasticity and damage tolerance. These advantages are because of their hierarchically built anatomy developed and optimized in a long-term genetic evolution process. There is a possibility of producing novel materials using preforms derived from naturally grown plant structures. The bio-structure derived preforms would have tremendous potential for synthesis of numerous materials with tailorable properties with a unique microstructure pseudomorphous to that of parent plants. Reference is made to a two-part article (“Biomorphic cellular silicon carbide ceramics from wood: I. Processing and Microstructure” by P. Greil, T. Lifka and A. Kaindl published in the J. Euro. Ceram. Soc. 18, 1961-1973 (1998) and “Biomorphic cellular silicon carbide ceramics from wood: II. Mechanical Properties” by P. Greil, T. Lifa and A. Kaindl published in the J. Euro. Ceram. Soc. 18, 1975-1983 (1998)) wherein the authors describe a method of making carbon preform by carbonizing wood (beech, oak, maple, pine, balsa and ebony) at 800-1800° C. for 4 hours in nitrogen atmosphere in a carbon heated furnace for further processing of SiC and other ceramic materials. The drawbacks of the referred work are requirement of high temperature, long carbonization cycle, selective atmosphere, and costly and sophisticated equipment for making carbon preform from wood specimens, which add on increasing the complexity of processing as well as the time and cost of production.

Reference is also made to a to an article (“Silicon/silicon carbide composites fabricated by infiltration of a silicon melt into charcoal” by D. W. Shin, S. S. Park, Y. H. Choa and K. Nihara, published in the J. Am. Ceram. Soc., 82[11] 3251-53 (1999)) wherein the authors showed the acceptability of commercial charcoal made from heating oak wood at a temperature of about 1000° C. in an inert atmosphere, as preforms for conventional processing of reaction bonded silicon carbide ceramic. The drawback of the referred work lies in the fact that the charcoal preforms made from oak wood contain hollow channels of various diameters that may give rise to generation in their places of secondary phases of different dimensions and shapes, affecting the final properties. The wide variation of channel diameters may also affect the subsequent inward infiltration of liquids through them while making materials from the preforms.

Reference is made to a to U.S. Pat. No. 6,124,028, entitled “Carbonized wood and materials formed therefrom” by Denis C. Nagle and Christopher E. Byrne, 26 Sep., 2000) wherein the authors describe a method of making carbonized preforms by heating woody specimens (Lignum vitae, red oak, balsa, basswood, maple, white pine, red wood) at 300 to 2000° C. using heat-up rates of 1 to 10° C. per hour between the temperatures of 200 and 400° C., less than 20° C. per hour after 400° C. and cooling rates of less than 100° C. per hour, under a non-oxidizing atmosphere which includes vacuum, noble gases or preferably nitrogen. The drawbacks of the referred work are very complex procedures because of requirement of very slow heat-up rates resulting in longer periods needed for attainment of peak temperature of carbonization, special atmosphere, higher carbonization temperature and sophisticated and expensive equipment.

Reference is made to a to an article (“Environment conscious ceramics (Ecoceramics)” by M. Singh published in Ceram. Eng. Sci. Proc., 21[4] 39-44 (2000)), wherein the author describes a method of fabrication of carbonaceous preform by pyrolyzing different types of wood specimens (Brazilian Rosewood, Africian Zebra, Ceylon Stainwood, Africian Bubinga, Pau Lope, Australian Jarrah and Indian Mango) at 1000° C. in flowing nitrogen atmosphere for subsequent use of the preforms for fabricating SiC-based ceramics. The preform properties such as pyrolysis shrinkage, composition and density, and its microstructure are reported to be varying greatly depending on the type of wood, and these variations are mostly tried to be utilized to produce final materials with controlled microstructure, composition and phase morphologies. The method of utilizing the variation of properties and microstructure obtained from various types of wood, without going into their detailed botanical classification and anatomical structural distinction, lacks fundamental approach and may be considered as main drawback of the referred work.

Reference is made to an article (“Biomimetic process for producing SiC wood” by T. Ota, M. Takahashi T. hibi, M. Ozawa, S. Suzuki and Y. Hikichi, published in the J. Am. Ceram. Soc., 78[12] 3409-11 (1995)) wherein the authors demonstrated the usage of oak charcoal as a precursor for making SiC in wood like structure by suitable sol infiltration followed by pyrolysis technique. The referred article does not contain the detailed information regarding fabrication and characterization of charcoal precursor, and hence, the drawbacks normally associated with the commercial oak charcoal as mentioned in the earlier reference, are also valid in the present case.

In the referred works, varieties of woods are used for making ‘carbonized preform’, or ‘pyrolyzed preform’ or simply ‘charcoal’ with characteristics measured only in terms of carbonization or pyrolysis weight loss, change in linear dimension, total porosity and pore size distribution etc. that vary greatly from wood to wood. These variations in properties of the preforms are utilized for further processing of materials using them. To make the variation in properties in preforms, precursor woods are selected mainly on the basis of being ‘hard’ or ‘soft’ and also on the basis of further such differences, e.g., ring porous or diffusive porous, in each selected category. Classification of woods as being ‘hard’ or ‘soft’ is not at all fundamental from botanical point of view.

Differentiation of preforms on the basis of the properties which are again dependant on the type of the precursor wood, is done in a way in the referred work that does not reflect the anatomical distinctions with respect to basic structural features of plant specimens; no studies have been found relating to the selection of the suitability of plant structure in terms of its anatomical feature, which after having been transformed to carbonaceous preform, helps gaseous transportation or liquid infiltration processing of numerous materials in significantly reduced periods of time.

No information has been reported relating to the methods by which pyrolytic transformation of plant structures to porous carbonaceous preforms can be done at relatively lower temperatures in ambient atmosphere, while retaining their anatomical features and mechanical integrity. The present invention has been developed in view of the foregoing and other deficiencies of the prior art.

In the process of the present invention, biopreform is made out of the stem of monocotyledonous caudex trees, which offers carbonaceous shape of cellular structure with unique macro- and micro-structural features isomorphous to the precursor plants. The novelty of the present invention is that unlike other processes of making bio-structure derived preforms, the biopreform in the present case is made with combination of unique properties, following a simple and inexpensive processing route because of using as starting material the caudex stem of a monocotyledonous plant, a locally available cheap agricultural product, so that it can ultimately be used as a novel material itself or it can make possible subsequent gaseous transportation or liquid infiltration processing of numerous materials in significantly shorter periods of time.

The “pyrolyzed preforms” or “carbonized preforms” or simply “charcoal” referred to in the prior art, are made from woody precursors, which turned out to be mostly dicotyledons, and occasionally gymnosperms. Such woods are characterized by:

(i) limited number of localized trachaedal pore channels arranged around the perimeter of the stem and vertically elongated along the stem axis

(ii) presence of woody tissues not aligned along the stem axis due to the presence of cambium responsible for increasing the girth of the stem

(iii) presence of divalent cations bound in the cell walls that form ionic or covalent cross-links (cross-walls) transverse to the direction of growth and inhibiting extension of cell walls in the direction of stem axis

(iv) microfibrils in the cross-walls which are random and lack preferred orientation

The “pyrolyzed preforms” or “carbonized preforms” etc. resulting from such woody precursors are endowed with:

(i) a complex carbonaceous skeletal structure with limited number of localized trachaedal pore channels vertically elongated along the stem axis together with transverse and random carbonaceous residues coming from precursor cellular array and microfibrils in the cross-walls.

Moreover, high temperature processing in controlled atmospheres under subnormal or above-normal pressures that have been followed in the referred prior arts, are responsible for other associated features of the “preforms”, viz.,

(ii) loss or collapse of microstructural features characteristics of the woody precursors

(iii) carbon remnants with various degree of graphitization

(iv) retained typical mineral residues which, most probably, have already been transformed into stable compounds.

### OBJECT OF THE INVENTION

The main object of the invention is to provide a process of making biopreform from monocotyledonous caudex plant stem suitable for liquid infiltration and gaseous transportation processing of materials, which obviates the drawbacks as detailed above.

Another object of the invention is to provide a considerably simpler pyrolytic method of making preforms from naturally grown plant structures, the production of macro- and microstructure of biopreform isomorphous to the parent plant structure with high precision due to ambient heating, lower processing temperature and shorter holding periods.

Still another object of the invention is to provide a biopreform made from the caudex stem of a monocotyledonous plant, the anatomical structure of which can be highly advantageous for liquid infiltration because of the presence of plenty of vascular bundles randomly distributed in the ground tissue, that are retained in shape with high precision on pyrolytic transformation and can give increased contours, assuring faster infiltration and reaction of liquids or transportation of gases of suitable compositions.

Yet another object of the invention is to provide a biopreform that can be made following pyrolytic transformation, from the stem of a monocotyledonous caudex plant such as coconut (Cocos nucifera), palmyra palm (Borassus flabellifer), date palm (Phoenics dactylifera), abundantly available in tropical countries in general, and in particular in India.

### SUMMARY OF THE INVENTION

Accordingly the present invention provides a process of making a biopreform from monocotyledonous caudex plant stem that preserves the microstructural, structural and anatomical features of the plant precursor, which comprises preheating a piece of stem of a monocotyledonous caudex plant at a temperature in the range of 50 to 90° C., maintaining the preheated stem piece at the peak temperature, followed by heating the preheated stem piece in a closed container provided with a vent at a temperature in the range of 350 to 1000° C., maintaining the stem piece at the peak temperature under self-generated ambient atmosphere, followed by furnace cooling to obtain the biopreform.

In one embodiment of the invention, the monocotyledonous plant is selected from the group consisting of Cocos nucifera, Borassus flabellifer and Phoenics dactylifera.

In another embodiment of the invention, the amount of plant stem chosen comprises 4 to 13.4 gm.

In yet another embodiment of the invention, the preheating is carried out at the rate of 1 to 10° C. per minute till peak temperature is attained.

In yet another embodiment of the invention, the preheated stem piece is maintained at the peak temperature for a time period in the range of 24 to 48 hours.

In a further embodiment of the invention, the heating of the preheated stem piece is carried out at a rate of 1 to15° C. per minute.

In yet another embodiment of the invention, the reheated stem piece is maintained at the peak temperature for a time period of about 5 minutes.

The present invention also relates to a process for making a biopreform form a monocotyledonous caudex stem that preserves the microstructural, structural and anatomical features of the plant precursor, comprising the steps of
(i) selecting a piece of stem of a monocotyledonous caudex plant free from visible defects like knots or decay and with removed epidermis
(ii) subjecting the selected stem piece to preheating to a temperature in the range of 50 to 90° C.
(iii) maintaining the preheated stem piece at the peak temperature for a time period of 24 to 48 hours
(iv) further heating the stem piece in a closed container provided with a vent at a temperature in the range of 350 to 1000° C.
(v) maintaining the further heated stem piece for a time period of 5 minutes at the peak temperature under self-generated ambient atmosphere
(vi) furnace cooling the further heated stem piece to obtain the biopreform.

In one embodiment of the invention, the monocotyledonous plant is selected from the group consisting of Cocos nucifera, Borassus flabellifer and Phoenics dactylifera.

In another embodiment of the invention, the amount of plant stem chosen comprises 4 to 13.4 gm.

In yet another embodiment of the invention, the preheating is carried out at the rate of 1 to 10° C. per minute till peak temperature is attained.

In a further embodiment of the invention, the heating of the preheated stem piece is carried out at a rate of 1 to 15° C. per minute.

The present invention also relates to a biopreform made from stems of monocotyledonous caudex stems that preserves the microstructural, structural and anatomical features of the plant precursor, comprising
(a) randomly distributed small trachaedal channels vertically elongated along the stem axis
(b) substantially straight grains and longitudinal orientation of trachaedal channels parallel to the stem axis without secondary growth due to absence of cambium
(c) woven and ordered microfibrils surrounding and defining the conducting channels
(d) minimal cross-walls perpendicular to the stem axis due to absence of cambium
(e) leaf-trace bundles passing singly into the stem
(f) containing mineral elements such as silicon

In one embodiment of the invention, the monocotyledonous plant is selected from the group consisting of Cocos nucifera, Borassus flabellifer and Phoenics dactylifera.

In another embodiment of the invention, the amount of plant stem chosen comprises 4 to 13.4 gm.

In yet another embodiment of the invention, the biopreform has multi-dimensional pore sizes comprising big pores of diameter in the range of 60 to 130 μm, medium pores of diameter in the range of 5 to 25 μm and small pores of diameter in the range of 1 to 6 μm.

The present invention also relates to a method for making composite materials using biopreforms obtained from stem pieces of monocotyledonous plants said biopreform comprising
(a) randomly distributed small trachaedal channels vertically elongated along the stem axis
(b) substantially straight grains and longitudinal orientation of trachaedal channels parallel to the stem axis without secondary growth due to absence of cambium
(c) woven and ordered microfibrils surrounding and defining the conducting channels
(d) minimal cross-walls perpendicular to the stem axis due to absence of cambium
(e) leaf-trace bundles passing singly into the stem
(f) containing mineral elements such as silicon
   by incorporating the composite material into the biopreform.

In one embodiment of the invention, the composite material is selected from the group consisting of carbon-epoxy, carbon-carbon, carbon-metal, carbon-silicon carbide, carbon-metal oxide, silicon-silicon carbide, metal-silicon carbide, transitional metal silicide-silicon carbide, aluminium oxide-aluminium nitride and silica-silicon nitride.

In another embodiment of the invention, the composite material is incorporated into the biopreform by a method selected from the group consisting of gaseous transportation, liquid infiltration, reaction, substitution and any combination thereof

In one embodiment of the invention, the monocotyledonous plant is selected from the group consisting of Cocos nucifera, Borassus flabellifer and Phoenics dactylifera.

In another embodiment of the invention, the amount of plant stem chosen comprises 4 to 13.4 gm.

In yet another embodiment of the invention, the biopreform has multi-dimensional pore sizes comprising big pores of diameter in the range of 60 to 130 μm, medium pores of diameter in the range of 5 to 25 μm and small pores of diameter in the range of 1 to 6 μm.

### DETAILED DESCRIPTION OF THE INVENTION

The present invention describes a process for making carbonaceous preforms that are improved in respect of preserving the biological cellular structure of the precursor material and thus can be called “biopreforms” and are uniquely different from those derived from woods of dicotyledons or gymnosperms. The novelty of the present invention lies in making biopreforms that are endowed with:

(i) large number of smaller trachaedal pores elongated along the stem axis and randomly distributed

(ii) predominance of longitudinally oriented trachaedal channel porosity

(iii) microchannels and micropores ordered and oriented longitudinally arising out of the woven and ordered microfibrils

(iv) additional longitudinal passages derived from leaf-trace bundles

(v) reactive skeletal carbon remnants retaining the macro- and microstructural features of the precursor plant with high degree of precision

(vi) reactive mineral residues typical of monocotyledonous caudex stems

Such biopreforms provide ready and increased contour for rapid infiltration of liquids of suitable compositions with or without simultaneous reactions therewith or subsequent further processing to produce in a considerable shorter period of time, a variety of materials with unique properties and cellular macro- and microstructure nearly isomorphous to the precursor plants.

The biopreform prepared by the process of the invention are useful in preparation of dense or lightweight ceramic composite materials of many different types with anisotropic mechanical and other properties. Composites of the types of carbon-epoxy, carbon-carbon, carbon-metal, carbon-silicon carbide, carbon-metal oxide, silicon-silicon carbide, metal-silicon carbide, transitional metal silicide-silicon carbide, aluminium oxide-aluminium nitride, silica-silicon nitride and various modifications of them can be obtained through the process of gaseous transportation or liquid infiltration, reaction and substitution or suitable combination of such processes.

These materials find applications in space and aero-space sectors, in automobile industries, in sports equipment industries, and as structural materials in different engineering sectors. The cellular structure is maintained with anisotropic porosity of precursor wood in the biopreform making it ideally suited for gas transport infiltration in the axial direction. Thus, the biopreform finds use as filters in gas separation and absorbents for medical or other applications.

The preparation of a biopreform that is substantially isomorphous to the monocotyledonous caudex stem precursor and suitable for liquid infiltration and gaseous transportation processing of composite materials is possible due to:
(i) selection of stems of monocotyledonous caudex trees characterized by:
   (a) large number of smaller trachaedal channels randomly distributed and vertically elongated along the stem axis
   (b) extremely high straightness of grains and predominantly longitudinal orientation of trachaedal channels parallel to the stem axis without secondary growth due to absence of cambium
   (c) woven and ordered microfibrils surrounding and defining the conducting channels
   (d) minimized cross-walls perpendicular to the stem axis due to absence of cambium
   (e) numerous leaf-trace bundles passing singly into the stem
   (f) presence of typical mineral elements (such as silicon)
(ii) drying or preheating of the piece of stem of monocotyledonous caudex tree at low temperature using a slow heating rate
(iii) pyrolytic transformation treatment at 350 to 1000° C. under self-generated ambient atmosphere at near normal pressures using a slow heating rate.

The main purpose of drying or preheating is to eliminate moisture from the pores and micropores of the woody stem. Preheating of trachaedal channel is preferably done at a relatively lower temperature with gentle and non-aggressive heating rate of 1 to 2° C. per minute in order to preserve the original cellular structure of parent plant material in the dried wood. The selection of 65° C. as the preheating temperature, is primarily based on two facts:

(i) it is a common practice to use molten paraffin (melting at 60 to 65° C.) in histological studies (ret “Histochemistry: Theoretical and Applied”, by G.Everson Pearse, Vol.I & II, 4^{th} Edition, 1985, Churchil Livingstone)

(ii) plant cell nuclear materials are stable up to 65 to 70° C. (ref “Plant Biochemistry”, Ed. by James Bonner and J. E. Verner, Academic Press, 1965, pp. 49-50)

In both the cases, retention of cellular structure is achieved with high precision. The preheating is continued for a period of 24 to 48 hours for completion to obtain constant weight of the preheated product.

Thermogravimetry of dry or preheated powdered monocotyledonous caudex woody specimen indicates that pyrolytic weight loss is practically completed by 600° C. Slow heating at a rate up to 5° C. per minute, up to 750 to 800° C., of preheated monocotyledonous caudex stem specimen is done under self-generated ambient environment at near-normal pressure without vacuum or flow of inert gases (nitrogen or argon) so that
(i) pyrolysis is complete
(ii) no collapse or distortion of cellular structure takes place
(iii) no graphitization takes place
(iv) mineral residues are not converted into stable compounds,
   ensuring that the biological structural features of the parent plant are preserved in the resulting shape of porous carbonaceous residue—the biopreform.

Heating at lower temperatures results in incomplete pyrolysis. Heating at higher temperatures causes partial oxidation of biopreform and tends to transform the residual minerals into stable products. Higher heating rates and higher heating temperatures denature the cell structure and destroy the near-isomorphous structural features of the precursor plant in the biopreforms.

Synthesis of biopreforms from stems of monocotyledonous caudex trees at lower temperatures and near-normal pressures and under self-generated ambient atmosphere, with characteristics suitable for rapid liquid infiltration or gaseous transportation processing of materials, is a new and unique method.

The biopreform obtained from monocotyledonous caudex plant stem suitable for liquid infiltration and gaseous transportation processing of materials, overcomes the drawbacks of the prior art. The pyrolytic method considerably simplifies when compared to conventional processes of making preforms from naturally grown plant structures, the production of macro- and microstructure of biopreform isomorphous to the parent plant structure with high precision because of ambient heating, lower processing temperature and shorter holding periods. The anatomical structure of the biopreform made from the caudex stem of a monocotyledonous plant is highly advantageous for liquid infiltration because of the presence of plenty of vascular bundles randomly distributed in the ground tissue, that are retained in shape with high precision on pyrolytic transformation and give increased contours, assuring faster infiltration and reaction of liquids or transportation of gases of suitable compositions.

Another significant advantage of the invention is that the biopreform is made by pyrolytic transformation from the stem of a monocotyledonous caudex plant such as coconut (Cocos nucifera), palmyra palm (Borassus flabellifer), date palm (Phoenics dactylifera), that are in abundance in tropical countries such as India (which is the third largest producer of coconuts in the world. The native people of India traditionally use their fruits, leaves and various parts to derive food, beverages and varieties of essential items of their livelihood. In fact, the trees indispensable parts of their social and cultural lives).

The present invention provides a process of making a biopreform that preserves the microstructural, structural and anatomical features of typical plant precursor, comprising of a process of making the biopreform from the monocotyledonous caudex plant stem, suitable for liquid infiltration and gaseous transportation processing of materials, by preheating 4 to 13.4 gm of a piece of stem of a monocotyledonous caudex plant such as coconut (Cocos nucifera), palmyra palm (Borassus flabellifer), date palm (Phoenics dactylifera), at a temperature in the range of 50 to 90° C. preferably using a heating rate of 1 to 10° C. per minute, holding for a period of 24 to 48 hours at the peak temperature followed by heating the said preheated specimen in a closed container provided with a vent at a temperature in the range of 350 to 1000° C. preferably using a heating rate of 1 to 15° C. per minute, holding for a period of 5 minutes at the peak temperature under self-generated ambient atmosphere followed by furnace cooling.

The process of the invention is preferably carried out using the following steps:

(i) 4 to 13.4 gm of a piece of stem of a monocotyledonous caudex plant such as coconut (Cocos nucifera), palmyra plam (Borassus flabellifer), date palm (Phoenics dactylifera), free from visible defects like knots or decay and with removed epidermis are selected

(ii) the specimens are preheated to a temperature in the range of 50 to 90° C. using a heating rate of 1 to 10°C. per minute, holding for a period of 24 to 48 hours at the peak temperature

(ii) the specimens are further heated in a closed container provided with a vent at a temperature in the range of 350 to 1000° C. using a heating rate of 1 to 15° C. per minute, holding for a period of 5 minutes at the peak temperature under self-generated ambient atmosphere

(iv) The specimens are then furnace-cooled to produce final biopreform

The following examples are given by way of illustration and therefore should not be construed to limit the scope of the present invention.

### EXAMPLE 1

A piece of stem of coconut tree, weighing 8.23 gm, free from visible defects like knots or decay and with removed epidermis, was preheated at a temperature of 50° C. for 24 hours using a heating rate of 1° C. per minute.

It was further heated in a closed container provided with a vent at a temperature of 350° C. for 5 minutes under self-generated ambient atmosphere using a heating rate of 1° C. per minute and then furnace cooled.

The product was analyzed by measurement of weight and was found to have 61% weight loss. It was further viewed by visual examination and by optical microscopy. Cracked product was obtained. Some wood-cell organic matter was clearly seen in microscopic observations, which may be present due to incomplete pyrolytic transformation at low temperature.

### EXAMPLE 2

A piece of stem of coconut tree, weighing 8.23 gm, free from visible defects like knots or decay and with removed epidermis, was preheated at a temperature of 65° C. for 48hours using a heating rate of 1° C. per minute. It was further heated in a closed container provided with a vent at a temperature of 350° C. for 5 minutes under self-generated ambient atmosphere using a heating rate of 1° C. per minute and then furnace cooled.

The product was analyzed by measurement of linear dimensions and weight and was found to have shrinkages of 15, 25 and 20% of length, width and thickness respectively; 63% weight loss was found. It was fuirther viewed by visual examination and by optical microscopy. No crack was obtained, but wood-cell organic matter was seen to be present in microscopic observations, probably due to incomplete pyrolytic transformation at low temperature.

### EXAMPLE 3

A piece of stem of coconut tree, weighing 8.23 gm, free from visible defects like knots or decay and with removed epidermis, was preheated at a temperature of 65° C. for 48 hours using a heating rate of 10° C. per minute. It was further heated in a closed container provided with a vent at a temperature of 350° C. for 5 minutes under self-generated ambient atmosphere using a heating rate of 1° C. per minute and then furnace cooled.

The product was analyzed by measurement of weight and was found to have 63% weight loss. It was further viewed by visual examination and by optical microscopy. Cracked product was obtained. Some wood-cell organic matters was clearly seen in microscopic observations, which may be present due to incomplete pyrolytic transformation at low temperature.

### EXAMPLE 4

A piece of stem of coconut tree, weighing 8.23 gm, free from visible defects like knots or decay and with removed epidermis, was preheated at a temperature of 90° C. for 24 hours using a heating rate of 1° C. per minute. It was further heated in a closed container provided with a vent at a temperature of 350° C. for 5 minutes under self-generated ambient atmosphere using a heating rate of 1° C. per minute and then furnace cooled.

The product was analyzed by measurement of weight and was found to have 67% weight loss. It was further viewed by visual examination and by optical microscopy. Crack product was obtained. Some wood-cell organic matters was clearly seen in microscopic observations, which may be present due to incomplete pyrolytic transformation at low temperature.

### EXAMPLE 5

A piece of stem of coconut tree, weighing 8.23 gm, free from visible defects like knots or decay and with removed epidermis, was preheated at a temperature of 65° C. for 48 hours using a heating rate of 1° C. per minute. It was further heated in a closed container provide with a vent at a temperature of 700° C. for 5 minutes under self-generated ambient atmosphere using a heating rate of 1° C. per minute and then furnace cooled.

The product was analyzed by measurement of linear dimensions and weight and was found to have shrinkages of 19, 28 and 26% of length, width and thickness respectively; 71% weight loss was found. It was fither viewed by visual examination and by optical microscopy. No crack was obtained and the structural integrity was seen to be preserved. In microscopic observation, tubular channels of vascular bundles were seen to be retained in shape. The multiplicity of hollow channels were clearly seen in the cross-sectional view. The biopreform is observed to contain multi-dimensional pore sizes, including big pores of diameter varying in the range of 60 to 110 μm, medium pores of diameter varying in the range of 5 to 15 μm and small pores of diameter varying in the range of 1 to 3 μM. The biopreform was further characterized by XRD analysis and found to contain mostly non-graphitic carbon.

### EXAMPLE 6

A piece of stem of coconut tree, weighing 8.23 gm, free from visible defects like knots or decay and with removed epidermis, was preheated at a temperature of 65° C. fbr 48 hours using a heating rate of 1° C. per minute. It was further heated in a closed container provided with a vent at a temperature of 750° C. for 5 minutes under self-generated ambient atmosphere using a heating rate of 1° C. per minute and then furnace cooled.

The product was analyzed by measurement of linear dimensions and weight and was found to have shrinkages of 20, 30 and 32% of length, width and thickness respectively. 72.9% weight loss was found. It was further viewed by visual examination and by optical microscopy. No crack was obtained and the structural integrity was seen to be preserved. In microscopic observation, tubular channels of vascular bundles were seen to be retained in shape. The multiplicity of hollow channels were clearly seen in the cross-sectional view. The biopreform has been observed to be containing multi-dimensional pore sizes, including big pores of diameter varying in the range of 70 to 120 μm, medium pores of diameter varying in the range of 6 to 20 μm and small pores of diameter varying in the range of 1 to 5 μm. The biopreform was further characterized by XRD analysis and found to contain non-graphitic carbon.

### EXAMPLE 7

A piece of stem of palmyra palm tree, weighing 13.4 gm, free from visible defects like knots or decay and with removed epidermis, was preheated at a temperature of 65° C. for 48 hours using a heating rate of 1° C. per minute. It was further heated in a closed container provided with a vent at a temperature of 750° C. for 5 minutes under self-generated ambient atmosphere using a heating rate of 1° C. per minute and then furnace cooled.

The product was analyzed by measurement of linear dimensions and weight and was found to have shrinkages of 20, 35 and 29% of length, width and thickness respectively; 72.5% weight loss was found. It was fuirther viewed by visual examination and by optical microscopy. No crack was obtained and the structural integrity was seen to be preserved. The biopreform was further characterized by XRD analysis and found to contain non-graphitic carbon.

### EXAMPLE 8

A piece of stem of coconut tree, weighing 4.00 gm, free from visible defects like knots or decay and with removed epidermis, was preheated at a temperature of 65° C. for 48 hours using a heating rate of 1° C. per minute. It was further heated in a closed container provided with a vent at a temperature of 750° C. for 5 minutes under self-generated ambient atmosphere using a heating rate of 1° C. per minute and then furnace cooled.

The product was analyzed by measurement of linear dimensions and weight and was found to have shrinkages of 20, 30 and 32% of length, width and thickness respectively; 72.9% weight loss was found. It was further viewed by visual examination and by optical microscopy. No crack was obtained and the structural integrity was seen to be preserved. In microscopic observation, tubular channels of vascular bundles were seen to be retained in shape. The multiplicity of hollow channels were clearly seen in the cross-sectional view. The biopreform has been observed to be containing multi-dimensional pore sizes, including big pores of diameter varying in the range of 70 to 120 μm, medium pores of diameter varying in the range of 6 to 20 μm and small pores of diameter varying in the range of 1 to 5 μm. The biopreform was further characterized by XRD analysis and found to contain non-graphitic carbon.

### EXAMPLE 9

A piece of stem of coconut tree, weighing 8.23 gm, free from visible defects like knots or decay and with removed epidermis, was preheated at a temperature of 65° C. for 48 hours using a heating rate of 1° C. per minute. It was further heated in a closed container provided with a vent at a temperature of 800° C. for 5 minutes under self-generated ambient atmosphere using a heating rate of 1° C. per minute and then furnace cooled.

The product was analyzed by measurement of linear dimensions and weight and was found to have shrinkages of 22, 32 and 34% of length, width and thickness respectively; 73.5% weight loss was found. It was further viewed by visual examination and by optical microscopy. No crack was obtained and the structural integrity was seen to be preserved. In microscopic observation, tubular channels of vascular bundles were seen to be retained in shape. The multiplicity of hollow channels were clearly seen in the cross-sectional view. The biopreform has been observed to be containing multi-dimensional pore sizes, including big pores of diameter varying in the range of 80 to 130 μm, medium pores of diameter varying in the range of 8 to 25 μm and small pores of diameter varying in the range of 1 to 6 μm. The biopreform was further characterized by XRD analysis and found to contain non-graphitic carbon.

### EXAMPLE 10

A piece of stem of coconut tree, weighing 8.23 gm, free from visible defects like knots or decay and with removed epidermis, was preheated at a temperature of 65° C. for 48 hours using a heating rate of 1° C. per minute. It was further heated in a closed container provided with a vent at a temperature of 700° C. for 5 minutes under self-generated ambient atmosphere using a heating rate of 15° C. per minute and then furnace cooled.

The product was analyzed by measurement of weight and was found to have 71% weight loss. It was further viewed by visual examination and by optical microscopy. Structural integrity was seen to be lost with cracks visible on the surface. In microscopic observation, breaking down of the cellular structure with appearance of cracks was observed from place to place.

### EXAMPLE 11

A piece of stem of coconut tree, weighing 8.23 gm, free from visible defects like knots or decay and with removed epidermis, was preheated at a temperature of 65° C. for 48 hours using a heating rate of 1° C. per minute. It was further heated in a closed container provided with a vent at a temperature of 1000° C. for 5 minutes under self-generated ambient atmosphere using a heating rate of 1° C. per minute and then furnace cooled.

The product was analyzed by measurement of weight and was found to have shrinkages 80% weight loss. Whitish powdery material appeared on the surface-which are easily dislodged and reveal the black carbonaceous preform beneath the surface. It was further viewed by visual examination and by optical microscopy. Cracks were visible on outer surface and structural integrity was seen to be destroyed. In microscopic observation, carbonaceous skeletal structure was seen to have reacted in some places probably due to partial oxidation occurring because of higher temperature of pyrolytic transformation. Cracks and structural disintegration appeared to have taken place due to higher temperature for pyrolytic heating.

The Main Advantages of the Present Invention Are:

(i) cheap and easily available raw materials of local origin and of renewable and non-polluting sources for making biopreform

(ii) increased shape capability because of usage of readily machinable biopreform

(iii) low temperature and ambient atmosphere pyrolytic transformation facility

(iv) the biopreform enables further synthesis of numerous important materials including ceramic composites, with unique macro- and microstructure nearly isomorphous to the cellular structure of the parent plants, such as,

(a) carbon-carbon composites, (b) carbon-epoxy composite, (c) silica-silicon carbide composite, (d) silicon nitride -silicon carbide composite, (e) silicon-silicon carbide composite, (f) transitional metal (such as Mo, Zr, Ti Ta, Fe) silicides-silicon carbide composites, (g) alumina-aluminium nitride composite, (h) copper-silicon carbide composite, (i) aluminium-silicon carbide composite, (j) metal matrix composite such as carbon-magnesium and carbon-aluminium (j) porous cellular silicon carbide material

What is claimed is:

1. A biopreform made from a monocotyledonous caudex plant stem comprising (a) randomly distributed small trachaedal channels vertically elongated along the stem axis (b) substantially straight grains and longitudinal orientation of trachaedal channels parallel to the stem axis without secondary growth due to absence of cambium (c) woven and ordered microfibrils surrounding and defining the conducting channels (d) minimal cross-walls perpendicular to the stem axis due to absence of cambium (e) leaf-trace bundles passing singly into the stem and (f) mineral elements.

2. A biopreform as claimed in claim 1 wherein the monocotyledonous plant is selected from the group consisting of Cocos nucifera, Borassus flabellifer and Phoenics dactylifera.

3. A biopreform as claimed in claim 1 wherein the monocotyledonous caudex plant stem weighs in the range of 4 to 13.4 gm.

4. A biopreform as claimed in claim 1 wherein the biopreform has multi-dimensional pore sizes comprising big pores of diameter in the range of 60 to 130 μm, medium pores of diameter in the range of 5 to 25 μm and small pores of diameter in the range of 1 to 6 μm.
